(19) United States
(12) Patent Application Publication
(10) Pub. No.: US 2024/0279443 A1
(43) Pub. Date: Aug. 22, 2024

(54) RUBBER MIXTURE AND TYRE

(71) Applicant: Continental Reifen Deutschland GmbH, Hannover (DE)

(72) Inventors: Catarina Sà, Isernhagen (DE); Viktoria Pavon Sierra, Hannover (DE); Christian Weber, Garbsen (DE)

(73) Assignee: Continental Reifen Deutschland GmbH, Hannover (DE)

(21) Appl. No.: 18/570,648

(22) PCT Filed: Jun. 10, 2022
(86) PCT No.: PCT/DE2022/200125

§ 371 Date: Dec. 15, 2023

(30) Foreign Application Priority Data
Jun. 18, 2021 (DE) 10 2021 206 251.2

(51) Int. Cl. C08L 9/06; B60C 1/00

(52) U.S. Cl. CPC C08L 9/06; B60C 1/0016; C08L 2205/02; C08L 2207/324

(57) ABSTRACT

A sulfur-crosslinkable rubber mixture, especially for the tread of pneumatic vehicle tires, including at least the following constituents:
10 to 90 phr (parts by weight, based on 100 parts by weight of all rubbers in the mixture) of at least one solid, solution-polymerized, functionalized butadiene rubber, where the functionalization enables interaction with a polar filler, —at least one further diene rubber, —at least one liquid, modified diene polymer A having a weight-average molecular weight Mw by GPC of 500 to 50 000 g/mol, preferably 2000 to 10 000 g/mol, wherein the modification enables interaction with a polar filler and is present along the polymer backbone, and —10 to 300 phr of at least one silica.

### CROSS-REFERENCE TO RELATED APPLICATIONS

The present application is a National Stage Application under 35 U.S.C. § 371 of International Patent Application No. PCT/DE2022/200125 filed on Jun. 10, 2022, and claims priority from German Patent Application No. 10 2021 206 251.2 filed on Jun. 18, 2021, the disclosures of which are herein incorporated by reference in their entireties.

### TECHNICAL FIELD

The invention relates to a sulfur-crosslinkable rubber mixture, in particular for the tread of pneumatic vehicle tires.

The invention further relates to a pneumatic vehicle tire having a tread which at least partially consists of such a sulfur-vulcanized rubber mixture.

### BACKGROUND

Since the running properties of a tire, especially a pneumatic vehicle tire, depend to a great extent on the rubber composition of the tread, particularly high demands are placed on the composition of the tread mixture. For this reason, various attempts have been made to positively influence the properties of the tire through the variation of the polymer components, the fillers and the other admixtures in the tread mixture. It has to be taken into account here that an improvement in one tire property often brings a deterioration in another property; for example, an improvement in abrasion characteristics is typically associated with a deterioration in braking characteristics on a dry road. The highest demands are made on tread mixtures for car and van tires, for example, with regard to wet and dry braking, abrasion resistance, cut-and-chip characteristics, rolling resistance, service life and handling.

One known way of influencing tire properties such as abrasion, wet skid characteristics and rolling resistance is, for example, to use solution-polymerized styrene-butadiene copolymers with different microstructure. It is also possible to modify diene rubbers by undertaking end group modifications, couplings or hydrogenations. The various types of copolymer have a different effect on the vulcanizate properties and hence also on the tire properties.

Functionalized diene elastomers for silica-containing rubber mixtures for tires are described, for example, in EP 3 150 403 A1, EP 3 150 402 A1, EP 3 150 401 A1, DE 10 2015 218 745 A1 and DE 10 2015 218 746 A1.

Moreover, WO 2016198177 A1 discloses using a liquid polybutadiene that has been terminally organosilicon-modified and has a weight-average molecular weight M_{w} by GPC of 500 to 12 000 g/mol in rubber mixtures for tire treads having good properties.

The use of a liquid modified diene polymer A that has been modified with organosilicon groups along the polymer backbone is known, for example, from EP 3 785 929 A1.

### SUMMARY

It is an object of the invention to provide rubber mixtures for the treads of pneumatic vehicle tires which lead, in tires, to an improved level of wet grip and rolling resistance coupled with simultaneously high profile stiffness.

This object is achieved in accordance with the invention by a sulfur-crosslinkable rubber mixture, especially for the tread of pneumatic vehicle tires, comprising at least the following constituents:
10 to 90 phr (parts by weight, based on 100 parts by weight of all rubbers in the mixture) of at least one solid, solution-polymerized, functionalized butadiene rubber, where the functionalization enables interaction with a polar filler,
at least one further diene rubber,
at least one liquid, modified diene polymer A having a weight-average molecular weight M_{w} by GPC of 500 to 50 000 g/mol, preferably 2000 to 10 000 g/mol, wherein the modification enables interaction with a polar filler and is present along the polymer backbone, and
10 to 300 phr of at least one silica.

The unit “phr” (parts per hundred parts of rubber by weight) used in this document is the standard unit of quantity for mixture recipes in the rubber industry. The dosage of the parts by weight of the individual substances is always based here on 100 parts by weight of the total mass of all solid rubbers present in the mixture. The liquid, modified diene polymers A are not included among these solid rubbers.

It has been found that, surprisingly, the specific combination of a specific solid, solution-polymerized, functionalized butadiene rubber with a specific liquid, modified diene polymer A that has been modified with corresponding groups along the polymer backbone and not just at the polymer chain ends can give a silica-containing rubber mixture which, when used for treads of pneumatic vehicle tires, leads to tires having an improved level of wet grip and rolling resistance coupled with simultaneously high profile stiffness and hence good handling.

The rubber mixture contains 10 to 90 phr of at least one solid, solution-polymerized, functionalized butadiene rubber, wherein the functionalization allows interaction with a polar filler. It is also possible to use two or more solution-polymerized, functionalized butadiene rubbers.

Butadiene rubbers (polybutadiene, BR) used may be any of the types known to the person skilled in the art. These include so-called high-cis and low-cis types: butadiene rubber having a cis content of not less than 90% by weight is referred to as high-cis type and butadiene rubber having a cis content of less than 90% by weight as low-cis type. Preference is given to using a low-cis butadiene rubber having a cis content of less than 90% by weight, preferably between 20% and 50% by weight, e.g. Li—BR (lithium-catalyzed butadiene rubber).

The solution-polymerized, functionalized butadiene rubbers may have been end group-modified and/or functionalized along the polymer chains with a wide variety of different functionalizations (modifications) that enable an interaction with a polar filler. The functionalization may be that with hydroxyl groups and/or ethoxy groups and/or epoxy groups and/or siloxane groups and/or aminosiloxane and/or carboxyl groups and/or silane-sulfide groups. However, other modifications or functionalizations known to the person skilled in the art are also useful. It is also possible to provide different functionalizations at either end of the chain. Metal atoms may also be a constituent of the functionalizations.

The solution-polymerized, functionalized butadiene rubber may, as well as the functionalizations that enable interaction with polar fillers, such as silica, also have further functionalizations that enable interactions with nonpolar fillers, such as carbon black. For instance, the solution-polymerized, functionalized butadiene rubber may have been functionalized at one end of the chain with an organosilyl group containing amino groups and/or ammonium groups and functionalized at the other end of the chain with an amino group. The amino groups and/or ammonium groups can interact with carbon black. The amino groups may be primary, secondary or tertiary amino groups, which may also be in cyclic form. The amino group is preferably a cyclic diamine group. For this purpose, for example, N-(t-butyldimethylsilyl)piperazine may be added in combination with n-butyllithium in the polymerization.

In order to further improve the properties of the mixture with regard to rolling resistance in tires, it has been found to be advantageous when the solution-polymerized functionalized butadiene rubber has a glass transition temperature Tg by DSC of less than −40° C.

The glass transition temperature (Tg) of the polymers is determined by dynamic scanning calorimetry (DSC) to DIN 53765: 1994-03 or ISO 11357-2: 1999-03, calibrated DSC with low-temperature device, calibration according to instrument type and manufacturer's instructions, sample in aluminum crucible with aluminum lid, cooling to temperatures lower than −120° C. at 10° C./min).

The sulfur-crosslinkable rubber mixture contains at least one liquid diene polymer A that has been specially modified along the polymer backbone and has an average molecular weight M_{w} by GPC of 500 to 50 000 g/mol, preferably 2000 to 10 000 g/mol. The abbreviation M_{w} represents the weight-average molecular weight of polymers. The weight average M_{w} is determined by gel permeation chromatography (GPC with polybutadiene standard). The M_{w} figure is based here on the diene polymer A including the organosilicon modification.

The liquid modified diene polymer A in the mixture may have been modified on the polymer backbone with a wide variety of different groups that enable interaction with a polar filler. The liquid modified diene polymer A has preferably been modified with organosilicon groups along the polymer backbone.

The organosilicon group preferably has a unit of formula I):

(R¹R²R³)Si—X— (I)

where R¹, R² and R³ are independently selected from methoxy groups, ethoxy groups, phenoxy groups, methyl groups, ethyl groups and phenyl groups, where at least one of the R¹, R² und R³ groups in each case is a methoxy group, an ethoxy group or a phenoxy group, and where X is a divalent alkyl group having 1 to 18 carbon atoms. The presence of such units in the polymer backbone, i.e. along the polymer chain, has a particularly positive effect on the rolling resistance of tires.

In an advantageous embodiment, the R¹, R² and R³ radicals are the same within one molecule.

In a further advantageous embodiment, the R¹, R² and R³ radicals are methoxy and/or ethoxy groups.

The organosilicon groups having a unit of formula I) may be bonded to the polymer backbone via different chemical bonds, for example via thiourea, urea or amide groups.

In a preferred development of the invention, X is a divalent alkyl group having 2 to 4, preferably having 3, carbon atoms. In this way, particularly good interactions with other mixture constituents are achieved.

In order to further improve the rolling resistance and breaking characteristics of tires and to assure good producibility of the diene polymer A, it has been found to be advantageous when the average number of organosilicon groups per molecule is 0.5 to 5.

The modified diene polymer A is based on the polymerization of conjugated dienes. It is possible to use all the conjugated dienes known to the person skilled in the art, such as butadiene, isoprene and aromatic vinyl compounds.

Further conjugated dienes are, for example, 2,3-dimethylbutadiene, 2-phenylbutadiene, 1,3-pentadiene, 2-methyl-1,3-pentadiene, 1,3-hexadiene, 1,3-octadiene, 1,3-cyclohexadiene, 2-methyl-1,3-octadiene, 1,3,7-octatriene, myrcene and chloroprene.

The polymerization is based preferably on butadiene monomers and/or isoprene monomers.

The diene polymer A is a liquid polymer. A “liquid polymer” for the purposes of the present invention is a polymer which at 25° C. has a Brookfield method (method according to DIN EN ISO 2555) viscosity of not more than 30 000 mPas, more particularly of 500 to 30 000 mPas.

In a preferred embodiment of the invention, the diene polymer A is a polybutadiene and is thus based on butadiene monomers.

If the diene polymer A is a polybutadiene, it preferably has a vinyl content of 5% to 80%, preferably of 50% to 70%. The glass transition temperature Tg by DSC is −100 to −30° C., preferably −60 to −40° C. This gives rise to particularly good rolling resistance indicators.

The modified diene polymer A is present in the mixture preferably in amounts of 1 to 50 phr, more preferably 5 to 40 phr, most preferably 5 to 30 phr.

The rubber mixture contains at least one further diene elastomer which is not a solid, solution-polymerized, functionalized butadiene rubber with a functionalization that enables interaction with a polar filler. Diene elastomers or diene rubbers are rubbers which are formed by polymerization or copolymerization of dienes and/or cycloalkenes and thus have C═C double bonds either in the main chain or in the side groups.

The further diene elastomers may, for example, be natural polyisoprene and/or synthetic polyisoprene and/or further polybutadiene (butadiene rubber) and/or styrene-butadiene copolymer (styrene-butadiene rubber) and/or styrene-isoprene rubber and/or halobutyl rubber and/or polynorbornene and/or isoprene-isobutylene copolymer and/or ethylene-propylene-diene rubber. The rubbers may be used as pure rubbers or in oil-extended form.

In a preferred embodiment of the invention, the at least one diene rubber is selected from the group consisting of polyisoprene (IR), further butadiene rubber (BR), solution-polymerized styrene-butadiene rubber (SSBR) and emulsion-polymerized styrene-butadiene rubber (ESBR). The rubbers mentioned may be used in a blend.

The rubber mixture of the invention preferably contains more than 5 phr natural polyisoprene (NR). Natural polyisoprene is understood to mean rubber that can be obtained by harvesting from sources such as rubber trees (Hevea brasiliensis) or non-rubber tree sources (for example guayule or dandelion (e.g. Taraxacum koksaghyz)). Natural polyisoprene (NR) is understood to mean nonsynthetic polyisoprene. Natural polyisoprenes from various sources may also be used in a blend. The cis-1,4 content in the natural rubber is greater than 99% by weight.

The rubber mixture of the invention contains 10 to 300 phr, preferably 50 to 170 phr, more preferably 85 to 120 phr, of silica in order to achieve good processibility coupled with good tire properties. Both the functionalized butadiene rubber and the modified diene polymer A may interact with the silica via their functionalization or modification groups.

It is possible to use a wide variety of different silicas, such as “low-surface area” or highly dispersible silica, including in a mixture. It is particularly preferable when a finely divided, precipitated silica is used, having a CTAB surface area (to ASTM D 3765) of 30 to 350 m²/g, preferably of 110 to 250 m²/g. Silicas used may be either conventional silicas, such as those of the VN3 type (trade name) from Evonik, or highly dispersible silicas known as HD silicas (e.g. Ultrasil 7000 from Evonik).

The rubber mixture may also comprise further fillers, such as carbon blacks, aluminosilicates, chalk, starch, magnesium oxide, titanium dioxide, rubber gels, carbon nanotubes, graphite, graphene or “carbon-silica dual-phase fillers” in customary amounts, where the fillers may be used in combination.

If carbon black is present in the rubber mixture, it is possible to use any of the carbon black types known to the person skilled in the art. Preference is given, however, to using a carbon black having an iodine adsorption number to ASTM D 1510 of 30 to 180 g/kg, preferably 30 to 130 kg/g, and a DBP number to ASTM D 2414 of 80 to 200 ml/100 g, preferably 100 to 200 ml/100 g, more preferably 100 to 180 ml/100 g. For the application in the vehicle tire, this achieves particularly good rolling resistance indicators (resilience at 70° C.) combined with other good tire properties.

For improvement of processibility and for binding of the silica to the diene rubber in silica-containing mixtures, preference is given to using at least one silane coupling agent in amounts of 1-15 phf (parts by weight, based on 100 parts by weight of silica) in the rubber mixture.

The expression phf (parts per hundred parts of filler by weight) used in this text is the conventional unit of quantity for coupling agents for fillers in the rubber industry. In the context of the present application, phf relates to the silica present, meaning that any other fillers present, such as carbon black, are not included in the calculation of the amount of silane coupling agent.

The silane coupling agents react with the surface silanol groups of the silica or other polar groups during the mixing of the rubber/the rubber mixture (in situ) or in the context of a pretreatment (premodification) even before addition of the filler to the rubber. Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH₂ or —Sₓ— (with x=2-8). Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of the sulfides having 1 to 8 sulfur atoms with different contents of the various sulfides. TESPT may for example also be added as a mixture with carbon black (trade name X50S from Degussa). Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is possible to use, for example, silanes which are sold under the NXT® name in a number of variants by Momentive, USA, or those that are sold under the VP Si 363 name by Evonik Industries. Also usable are “silated core polysulfides” (SCPs, polysulfides with a silylated core), which are described, for example, in US 20080161477 A1 and EP 2 114 961 B1.

The rubber mixture may include plasticizers and resins in amounts of 1 to 300 phr, preferably of 5 to 150 phr, more preferably 15 to 90 phr. Plasticizers that can be used include all the plasticizers that are known to those skilled in the art, such as aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL), preferably having a content of polycyclic aromatics of less than 3% by weight according to method IP 346 or rapeseed oil or factices or plasticizer resins, such as different hydrocarbon resins or resins based on natural sources.

The plasticizer(s) is/are preferably added in at least one primary mixing stage in the production of the rubber mixture of the invention.

The rubber mixture can further comprise customary additives in customary parts by weight which are added preferably in at least one primary mixing stage during the production of said mixture. These additives include
a) aging inhibitors, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ),
b) activators, for example zinc oxide and fatty acids (e.g. stearic acid) or zinc complexes, for example zinc ethylhexanoate,
c) waxes,
d) masticating aids, for example 2,2′-dibenzamidodiphenyl disulfide (DBD), and
f) processing aids, for example fatty acid salts, for example zinc soaps, and fatty acid esters and derivatives thereof.

The proportion of the total amount of further additives is 3 to 150 phr, preferably 3 to 100 phr and particularly preferably 5 to 80 phr.

The vulcanization of the rubber mixture is conducted in the presence of sulfur and/or sulfur donors with the aid of vulcanization accelerators, it being possible for some vulcanization accelerators to act simultaneously as sulfur donors. The accelerator is selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators.

It is preferable to use a sulfenamide accelerator selected from the group consisting of N-cyclohexyl-2-benzothiazolesulfenamide (CBS) and/or N,N-dicyclohexylbenzothiazole-2-sulfenamide (DCBS) and/or benzothiazyl-2-sulfenomorpholide (MBS) and/or N-tert-butyl-2-benzothiazylsulfenamide (TBBS).

It is also possible for the rubber mixture to comprise vulcanization retardants.

The sulfur donor substances used may be any sulfur donor substances known to those skilled in the art. If the rubber mixture comprises a sulfur donor substance, it is preferably selected from the group consisting of, for example, thiuram disulfides, for example tetrabenzylthiuram disulfide (TBzTD), tetramethylthiuram disulfide (TMTD) or tetraethylthiuram disulfide (TETD), thiuram tetrasulfides, for example dipentamethylenethiuram tetrasulfide (DPTT), dithiophosphates, for example DipDis (bis(diisopropyl)thiophosphoryl disulfide), bis(O,O-2-ethylhexylthiophosphoryl) polysulfide (e.g. Rhenocure SDT 50®, Rheinchemie GmbH), zinc dichloryldithiophosphate (e.g. Rhenocure ZDT/S®, Rheinchemie GmbH) or zinc alkyldithiophosphate, and 1,6-bis(N,N-dibenzylthiocarbamoyldithio)hexane and diaryl polysulfides and dialkyl polysulfides.

Further network-forming systems as obtainable, for example, under the trade names Vulkuren®, Duralink® or Perkalink® or network-forming systems as described in WO 2010/049216 A2 may also be used in the rubber mixture. The latter system contains a vulcanizing agent which crosslinks with a functionality of greater than four and at least one vulcanization accelerator.

In the course of production, preference is given to adding to the rubber mixture at least one vulcanizing agent selected from the group consisting of sulfur, sulfur donors, vulcanization accelerators and vulcanizing agents that crosslink with a functionality of greater than four in the final mixing stage. This makes it possible to produce a sulfur-crosslinked rubber mixture from the mixed finished mixture by vulcanization for use in rubber products, especially in pneumatic vehicle tires.

The terms “vulcanized” and “crosslinked” are used synonymously in the context of the present invention.

The rubber mixture is produced by the process which is customary in the rubber industry and in which a primary mixture comprising all constituents apart from the vulcanization system (sulfur and vulcanization-influencing substances) is firstly produced in one or more mixing stages. The finished mixture is produced by adding the vulcanization system in a final mixing stage. The finished mixture is processed further, for example, by an extrusion operation and converted to the appropriate shape. This is followed by further processing by vulcanization, wherein sulfur crosslinking takes place due to the vulcanization system added within the context of the present invention.

The rubber mixture can be used for a wide variety of different rubber products. It is preferably used for the production of pneumatic vehicle tires such as car, van, truck or two-wheeled vehicle tires, where the rubber mixture forms at least the part of the tread that comes into contact with the road.

In a pneumatic vehicle tire, the tread may consist of a single mixture designed in accordance with the invention. Frequently, however, pneumatic vehicle tires nowadays have a tread with what is called a cap/base construction. What is meant here by “cap” is the part of the tread that comes into contact with the road, being arranged radially on the outside (upper tread portion or tread cap). What is meant here by “base” is the part of the tread which is arranged radially on the inside, and hence does not come into contact with the road in driving operation, or does so only at the end of the tire lifetime (lower tread portion or tread base). In the case of a pneumatic vehicle tire having such a cap/base construction, at least the rubber mixture for the cap is designed according to the exemplary rubber mixture described herein.

The pneumatic vehicle tire of the invention may also have a tread consisting of various tread mixtures arranged alongside one another and/or one on top of another (multicomponent tread).

In the production of the pneumatic vehicle tire, the mixture is preferably brought into the shape of a tread, preferably at least into the shape of a tread cap, as a finished mixture prior to vulcanization, and applied in the known manner in the production of the vehicle tire blank. The tread, preferably at least the tread cap, can also be rolled up in the form of a narrow strip of rubber mixture onto a tire blank.

The invention comprises all advantageous embodiments which are reflected in the claims inter alia. The invention especially also comprises embodiments which result from a combination of different features, for example of constituents of the rubber mixture, with different levels of preference for these features, so that the invention also covers a combination of a first feature described as “preferred” or described in the context of an advantageous embodiment with a further feature described for example as “particularly preferred”.

### DETAILED DESCRIPTION

The invention is now to be illustrated in detail with reference to comparative examples and working examples, which are summarized in table 1.

The comparative mixtures here are labeled V, the inventive mixture E.

The mixture was produced by the methods customary in the rubber industry under standard conditions in three stages in a laboratory mixer, in which all the constituents apart from the vulcanization system (sulfur and vulcanization-influencing substances) were first mixed in the first mixing stage (primary mixing stage). In the second mixing stage the preliminary mixture was mixed again. By addition of the vulcanization system in the third stage (ready-mixing stage), the finished mixture was produced, with mixing at 90 to 120° C.

Subsequently, the loss factor tan δ (10%) of the mixture is determined by means of an RPA (rubber process analyzer) in accordance with ASTM D6601 from the second strain sweep at 1 Hz, 70° C. and 10% elongation.

In addition, all mixtures were used to produce test specimens by vulcanization for 20 minutes under pressure at 160° C., and these test specimens were used to determine material properties typical for the rubber industry by the following specified test methods:
Shore A hardness at room temperature by durometer according to DIN ISO 7619-1
Resilience at room temperature and 70° C. in accordance with DIN 53 512
Stress value at 300% elongation at room temperature in accordance with DIN 53 504

The values ascertained for loss factor tan δ (10%) as a measure of rolling resistance in tires, for resilience at room temperature as a measure of wet braking in tires and for resilience at 70° ° C. as a measure of the rolling resistance of tires were converted to a performance index, with normalization of the comparative mixture V1 to 100% performance for each property tested. All other mixture performances are based on this comparative mixture C1. In these figures, values <100% denote a deterioration in the properties, whereas values >100% represent an improvement.

TABLE 1

| | Unit | 1(V) | 2(V) | 3(V) | 4(E) |
|---|---|---|---|---|---|
| Constituents | | | | | |
| Natural rubber | phr | 10 | 10 | 10 | 10 |
| Functionalized BR ^{a} | phr | — | — | 30 | 30 |
| SSBR ^{b} | phr | 90 | 90 | 60 | 60 |
| Mod. liquid polybutadiene^{c} | phr | 15 | — | 15 | — |
| Modified diene polymer A^{d} | phr | — | 15 | — | 15 |
| Carbon black | phr | 5 | 5 | 5 | 5 |
| Silica^{e} | phr | 95 | 95 | 95 | 95 |
| Silane coupling agent^{f} | phr | 6.8 | 6.8 | 6.8 | 6.8 |
| Plasticizer | phr | 35 | 35 | 30 | 30 |
| Aging inhibitor | phr | 2 | 2 | 2 | 2 |
| Antiozonant wax | phr | 2 | 2 | 2 | 2 |
| Zinc oxide | phr | 2.5 | 2.5 | 2.5 | 2.5 |
| Stearic acid | phr | 2.5 | 2.5 | 2.5 | 2.5 |
| Accelerator | phr | 4 | 4 | 4 | 4 |
| Sulfur | phr | 2 | 2 | 2 | 2 |
| Properties | | | | | |
| tan δ (10%) index | % | 100 | 102 | 99 | 116 |
| Shore A hardness at RT | Shore A | 62.3 | 63.1 | 65.2 | 65.2 |
| Resilience index at RT | % | 100 | 118 | 95 | 106 |
| Resilience index at RT | % | 100 | 97 | 101 | 105 |
| Stress value at 300% | MPa | 8.0 | 6.6 | 9.0 | 8.1 |

^{a} Sprintan ® 884L, Trinseo, solution-polymerized, functionalized low-cis butadiene rubber with functionalization for the polymer/silica interaction, T_{g} = −91° C., cis content = 38%
^{b} Sprintan ® SLR-3402, Trinseo, functionalized, solution-polymerized styrene-butadiene copolymer with functionalization for the polymer/silica and the polymer/carbon black interaction, T_{g} = −62° C.
^{c}Polyvest ® EP ST-E 60, Evonik, terminally triethoxysilane-modified liquid polybutadiene, T_{g} = −80° C., average molar mass M_{w} about 3200 g/mol (GPC, polybutadiene standard)
^{d}liquid polybutadiene modified with triethoxysilane groups along the polymer backbone, M_{w} about 6000 g/mol, T_{g} = −50° C., vinyl content = 65%, degree of functionalization 2.0
^{e}VN3, Degussa AG, Germany, nitrogen surface area: 175 m²/g, CTAB surface area: 160 m²/g
^{f}TESPD, 3,3′-bis(triethoxysilylpropyl) disulfide

It is apparent from the data in table 1 that the presence of the specific solid, solution-polymerized, functionalized butadiene rubber and of the specific liquid, modified diene polymer A that has been modified with an organosilicon group along the polymer backbone and not just at the polymer chain ends surprisingly improves performance indices for rolling resistance (loss factor tan δ (10%) and resilience at 70° C.) and performance index for wet grip (resilience at RT) simultaneously. At the same time, the mixture of the invention, after vulcanization, is notable for a high stress modulus at 300% extension; this serves as an indicator for high profile stiffness and hence for good handling characteristics when the mixture is used for tire treads.

1.-11. (canceled)

12. A sulfur-crosslinkable rubber mixture, especially for the tread of pneumatic vehicle tires, comprising at least the following constituents:
10 to 90 phr (parts by weight, based on 100 parts by weight of all rubbers in the mixture) of at least one solid, solution-polymerized, functionalized butadiene rubber, where the functionalization enables interaction with a polar filler,
at least one further diene rubber,
at least one liquid, modified diene polymer A having a weight-average molecular weight M_{w} by GPC of 500 to 50 000 g/mol, wherein the modification enables interaction with a polar filler and is present along the polymer backbone, and
10 to 300 phr of at least one silica.

13. The sulfur-crosslinkable rubber mixture as claimed in claim 12, wherein the at least one liquid, modified diene polymer A has a weight-average molecular weight M_{w} by GPC of 2000 to 10 000 g/mol.

14. The sulfur-crosslinkable rubber mixture as claimed in claim 12, wherein the at least one solid, solution-polymerized, functionalized butadiene rubber has a cis content of less than 90% by weight.

15. The sulfur-crosslinkable rubber mixture as claimed in claim 12, wherein the at least one solid, solution-polymerized, functionalized butadiene rubber has a cis content between 20% and 50% by weight.

16. The sulfur-crosslinkable rubber mixture as claimed in claim 12, wherein the at least one liquid, modified diene polymer A having a weight-average molecular weight M_{w} by GPC of 500 to 50 000 g/mol has been modified with organosilicon groups along the polymer backbone.

17. The sulfur-crosslinkable rubber mixture as claimed in claim 16, wherein the organosilicon groups of the diene polymer A have a unit of formula I):
(R¹R²R³)Si—X— (I)
where R¹, R² and R³ are independently selected from methoxy groups, ethoxy groups, phenoxy groups, methyl groups, ethyl groups and phenyl groups, where at least one of the R¹, R² und R³ groups in each case is a methoxy group, an ethoxy group or a phenoxy group, and where X is a divalent alkyl group having 1 to 18 carbon atoms.

18. The sulfur-crosslinkable rubber mixture as claimed in claim 17, wherein X is a divalent alkyl group having 2 to 4 carbon atoms.

19. The sulfur-crosslinkable rubber mixture as claimed in claim 17, wherein X is a divalent alkyl group having 3 carbon atoms.

20. The sulfur-crosslinkable rubber mixture as claimed in claim 16, wherein the average number of organosilicon groups per molecule is 0.5 to 5.

21. The sulfur-crosslinkable rubber mixture as claimed in claim 18, wherein the average number of organosilicon groups per molecule is 0.5 to 5.

22. The sulfur-crosslinkable rubber mixture as claimed in claim 12, wherein the diene polymer A is a polybutadiene.

23. The sulfur-crosslinkable rubber mixture as claimed in claim 12 wherein the rubber mixture contains 5 to 50 phr of the at least one diene polymer A.

24. The sulfur-crosslinkable rubber mixture as claimed in claim 12, wherein the at least one further diene rubber is selected from the group consisting of polyisoprene (IR), further butadiene rubber (BR), solution-polymerized styrene-butadiene rubber (SSBR) and emulsion-polymerized styrene-butadiene rubber (ESBR).

25. The sulfur-crosslinkable rubber mixture as claimed in claim 12, wherein the rubber mixture contains more than 5 phr of natural polyisoprene.

26. A pneumatic vehicle tire having a tread, wherein at least the part of the tread that comes into contact with the road consists of a sulfur-vulcanized rubber mixture as claimed in claim 12.

27. A sulfur-crosslinkable rubber mixture, especially for the tread of pneumatic vehicle tires, comprising at least the following constituents:
10 to 90 phr (parts by weight, based on 100 parts by weight of all rubbers in the mixture) of at least one solid, solution-polymerized, functionalized butadiene rubber, where the functionalization enables interaction with a polar filler,
at least one further diene rubber,
at least one liquid, modified diene polymer A having a weight-average molecular weight M_{w} by GPC of 2000 to 10 000 g/mol, wherein the modification enables interaction with a polar filler and is present along the polymer backbone, and
10 to 300 phr of at least one silica.
wherein the at least one solid, solution-polymerized, functionalized butadiene rubber has a cis content between 20% and 50% by weight;
wherein the at least one liquid, modified diene polymer A has been modified with organosilicon groups along the polymer backbone,
wherein the organosilicon groups of the diene polymer A have a unit of formula I):
(R¹R²R³)Si—X— (I)
where R¹, R² and R³ are independently selected from methoxy groups, ethoxy groups, phenoxy groups, methyl groups, ethyl groups and phenyl groups, where at least one of the R¹, R² und R³ groups in each case is a methoxy group, an ethoxy group or a phenoxy group, and where X is a divalent alkyl group having 2 to 4 carbon atoms,
wherein the average number of organosilicon groups per molecule is 0.5 to 5.

28. The sulfur-crosslinkable rubber mixture as claimed in claim 27,
wherein the rubber mixture contains 5 to 50 phr of the at least one diene polymer A,
wherein the diene polymer A is a polybutadiene,
wherein the at least one further diene rubber is selected from the group consisting of polyisoprene (IR), further butadiene rubber (BR), solution-polymerized styrene-butadiene rubber (SSBR) and emulsion-polymerized styrene-butadiene rubber (ESBR), and
wherein the rubber mixture contains more than 5 phr of natural polyisoprene.

29. A pneumatic vehicle tire having a tread, wherein at least the part of the tread that comes into contact with the road consists of a sulfur-vulcanized rubber mixture as claimed in claim 27.
